(19) United States
(12) Patent Application Publication
(10) Pub. No.: US 2017/0054267 A1
(43) Pub. Date: Feb. 23, 2017

(54) VISIBLE WIDEBAND LASER FOR FLAT PANEL DISPLAY ILLUMINATION

(71) Applicant: George Michael Mihalakis, San Jose, CA (US)

(72) Inventor: George Michael Mihalakis, San Jose, CA (US)

(73) Assignee: George Michael Mihalakis, San Jose, CA (US)

(21) Appl. No.: 14/831,787

(22) Filed: Aug. 20, 2015

(51) Int. Cl. H01S 3/08; H01S 3/109; H01S 3/0933; H01S 3/10

(52) U.S. Cl. CPC H01S 3/08086; H01S 3/10061; H01S 3/10053; H01S 3/109; H01S 3/0933

(57) ABSTRACT

A method for producing wideband visible laser light wavelengths using planar photonic circuit elements for use in illuminating flat panel displays is shown.

### BACKGROUND

Many relevant flat panel display (FPD) technologies require an attendant means of flat illumination in order to function. This is particularly true for Liquid Crystal Display type panels (LCD). The modern transmissive LCD panel is by far the most prevalent and ubiquitous in all commercial display applications that include dominance in mobile, desktop and HDTV products, as well as in many portable image projectors. Often structured on glass, LCD panels are essentially transparent and most commonly configured to operate in a transmissive arrangement, requiring a flat illumination module located behind the viewed panel with a light emission field directed through the panel toward the viewer (i.e. a “backlight” module). Because the flat illumination in this arrangement is located behind the viewed LCD panel, the backlight module need not be substantially transparent.

Conversely, reflective LCD, Ink and Liquid-Crystal-on-Silicon (LCOS) display panels are opaque, thus requiring their flat illumination module to be located in front of the display panel, with its lighting emission field directed away from the viewer toward the display panel. The emitted illumination ultimately encounters the display panel's opaque reflection medium located directly successive to its image plane, such that the light emission field reflects back through the illumination module toward the viewer (i.e. a “frontlight” module). Because the flat illumination module in this arrangement is located in front of the viewed display panel, its frontlight components must be substantially transparent.

White light emitting LEDs, which generate color wavelengths across the entire visible spectrum, are nearly exclusively used as light sources in commercial edge-illuminated LCDs, despite that roughly two-thirds of the white LED emission spectrum must be subtracted as a substantial loss by filters in order to present the proper narrowband red, green and blue primaries to the display panel. Narrower band single-color LEDs are less frequently used to illuminate flat panel displays as additive primaries, chiefly due to the lack of a suitable green LED fab chemistry capable of efficiently providing mid-spectrum green emission.

Most conventional “edge-lit” LCD backlight illumination modules operate by transmitting diffuse white light from a plurality of LED emitters through one or more edges of a polished transparent dielectric lightguide sheet, wherein the fully diffuse light propagates throughout the lightguide by multiple total internal reflections (TIR), resulting in a randomized light flux distribution throughout the sheet's extent. Attendant to the lightguide in the backlight module component stack is a series of further diffusion elements and non-imaging optic films designed to scatter the light uncontrollably out of the lightguide so that a portion of it is extracted, collected, condensed and redirected through the LCD panel and outward toward the viewer.

This scheme of using a series of pure diffusers, including the diffuse LED light source itself, to extract and condense light from conventional backlight modules is wrought with inefficiency due to the optical physics principle of etendue. In essence, etendue is a measure of how much of the total light in the system remains collectable after each change in its angular and area containment, and how much becomes uncollectable and hence lost. The higher the etendue of a light source or optical element, the higher the portion of light that remains unusable after each interaction in the system. The purely diffuse light launched into conventional backlights by the diffuse LED source itself, which is then further diffused by subsequent components, creates the highest possible degree of geometric randomness of the light rays, the highest possible amount of uncollectable rays, and the worst possible increases in etendue. Its only advantage is simplicity, and perhaps also that there is currently no low-etendue commercial light source to replace it.

Thus it is the high etendue LED light source itself that is the root cause of the poor efficiency in the conventional commercial LCD backlights, which operate at about 3.5% efficiency in flux out vs. flux in. The high-etendue LED light source is the first element in a series of pure diffuser elements constituting a commercial standard backlight module that multiplicatively loses light flux. It sets the system etendue point to its highest possible maximum by launching a fully randomized 2n distribution of indirect light into the illumination module, which cannot be transformed efficiently into a contained beam of directional rays so that most light rays remain collectable.

It is the high-etendue LED light source that drives the design of the LCD backlight toward full randomization at the outset, rendering efficient beam transforms impossible.

Overall, LED light sources are a poor match to LCDs:

LCDs require polarized light to operate; LEDs emit unpolarized light (50% loss).
LCDs require balanced RGB color primaries; LEDs emit unbalanced white light (×60% loss).
LCDs need efficient BLU collection and condensing transforms to create brightness gain; LEDs emit poorly collectable and transformable diffuse light (×64% loss).
LCDs need good light source edge transmission into the lightguide; LEDs have edge-proximity inverse-square loss (×15% loss).
LEDs also lead to color gamut loss (due to poor primary color balancing), and contrast loss (due to wide angle stray light).

A purely directional light source, such as a laser light source, may overcome these limitations and drive LCD backlight design toward contained specular beams of very low etendue, and as a result enable high flux, brightness gain and battery power efficiencies. Replacing rows of multiple LED light sources with one or two laser light sources specifically conceived and embodied for use in the flat edge-lit illumination of LCD and other relevant flat panel displays significantly improves LCD power and flux efficiencies, brightness gain and other important display performance metrics. A better match to the basic functionality of LCD panels, a properly adapted laser light source operates at lower etendue points than LEDs and directly emits polarized light and well-balanced pure primary colors. A laser of this type enables new backlight design concepts that use low-etendue contained beams and efficient transforms rather than a series of diffusers.

However, several historical problems have here-to-fore prevented this achievement. The first is visible laser speckle. In a display, speckle is a wave interference artifact caused by the fundamental narrowband monochromatic nature of laser light when it interacts with material structures. This causes a source-induced fine luminance structure in the displayed image and a twinkling or scintillation in the image. When used in any display application, speckle is a serious problem with many if not all applicable commercially available visible light lasers.

The second problem is that established visible light emitting semiconductor laser diodes (LD) specifically do not work well in this application for emission wavelength reasons similar to LEDs. In addition to speckle, LDs, like LEDs, cannot produce efficient mid-spectrum green emission from either of the two existing process chemistries, GaAs for the red, and GaN for the blue. Neither gets close to the 550 nm center spectrum mandated by the color filters permanently designed into LCD panels and upon which a high quality image color gamut depends. Also, the process to fab visible emitting GaAs in production is not as robust and high-yield as the invisible near Infrared (IR) light LD emitters such as those produced by the telecom industry.

A third problem arises in the pursuit of mobile display applications, regarding the physical size dimensions, beam dimensions and packaging requirements of the mobile system products into which an LCD panel must operate. Smaller and thinner are typical constraints in most mobile flat panel display system products. Only planar, wafer-based photonic circuit devices are small enough and inexpensive enough to fit into smartphones and tablets.

Speckle removal or reduction that is intrinsic in a laser beam output can be achieved by the wavelength combining of a superposition of large numbers of independently lasing longitudinal modes. Green chemistry aside, this is still not feasible with conventionally packaged LDs. Even if large numbers of LDs are arranged over large areas and properly aimed at an aperture, the added source area and solid angle will vastly increase etendue and cost, and the total wavelength variation in identical LD wafers is not wide enough.

Wavelength combining as a method of producing higher power infrared (IR) laser beams from arrays of lower power LD IR beams has been prevalent in the near-infrared spectrum, largely due to the proliferation of telecom technology applications. This large diversity of IR devices and interconnects comprise photonic circuits that are produced using well-known planar, high volume wafer-based processes, rendering them small, reliable and inexpensive. Photonic circuit “chips” cut from a planar optical wafer substrate are analogous to electronic chips cut from a planar electronic wafer substrate. In contrast to electronic wafers, photonic wafer substrates are wholly comprised of optical materials. The circuit traces thereon are photon conductors, which are essentially waveguides that channel the near-IR light along tightly confined quantum boundaries formed by various optical materials.

Producing low etendue visible light laser beams comprised of mode bandwidths substantially wider and more continuous than the intrinsically narrow emission lines of conventional visible lasers is a key light source objective for flat panel display lighting. Mobile applications may particularly benefit from this development, wherein screens are small and thus required laser flux optical output power is lower than larger systems. Advances depicted in this art are established by the addition of a suitable wavelength conversion stage to convert the near-IR laser output of these telecom type planer circuits into visible light laser output suitable for display applications.

A near-IR laser power combining method is depicted in U.S. Pat. No. 7,265,896 B2 and U.S. Pat. No. 7,423,802 B2, wherein a linear array of identical near-IR semiconductor single mode laser diodes illuminate a conventional telecom type planar wavelength combiner circuit. The combiner circuit is comprised of a mating linear array of identical input waveguide traces, one abutted to each drive laser, and of waveguide face dimensions commensurate for confinement of the IR laser emission wavelength. All such waveguide input traces, upon traversing the details of the circuit, eventually combine into a single combiner output waveguide trace of confining dimensions identical to the input traces. A single feedback element located subsequent to the combiner output forms multiple optical cavities back through the combiner circuit, as the feedback element interconnects all laser cavities. As is conventional in telecom practice, a multi-cavity linear feedback convolution is induced by this arrangement, locking the frequency/wavelength mode of each drive laser to a lasing wavelength such that each differs slightly from the others, causing a fortified summation of all IR drive laser powers to appear at the single combiner output trace. This fortified output power appears distributed across the induced plurality of frequency/wavelength modes representative of the multi-feedback cavities, thereby significantly widening the total IR laser passband. This wavelength combining process is often used to launch many IR signals of slightly different wavelengths into a telecom fiber, each of which can be wavelength separated at the other end.

An intra-cavity planar nonlinear optic (NLO) harmonic generation element for the conversion of near-IR light to visible light is also described in U.S. Pat. No. 7,265,896 B2 and U.S. Pat. No. 7,423,802 B2. This planar NLO converter element resides subsequent to the wavelength combiner output trace and precedent to the feedback element output coupler, forming what now becomes a highly confined nonlinear cavity convolution feedback of the IR laser array that emits visible light. This arrangement thus delivers at the combiner output, visible light output of fortified power at widened bandwidth via one of several multi-photon processes common to nonlinear material, among them, second harmonic generation (SHG). Also disclosed in the aforementioned patents is a quasi-phase-matching structure attendant to the NLO material that minimizes optical interference and power transfer loss between drive wavelength and converted wavelength within the cavity.

While the prior art described herein indeed produces visible laser output with improved multimode bandwidth composition, the objective of this prior art is high power intensification using wavelength combining techniques to add the power of many IR laser light sources into a single high power output beam, without resulting in etendue losses. However most LCD applications, especially in the mobile space, because of small screen sizes and confined spaces, do not require high power visible light laser output. Nor is it practical to low power applications to achieve a speckle reducing widened passband from numerous coupled very low power drive lasers and a significant area of combiner circuitry. Rather, the application requires low power visible output with a widened passband achieved from one drive laser.

Thus the improved multimode passband output is essentially a byproduct of the prior art process described above, while it is the primary goal for mobile flat panel display lighting.

### BRIEF DESCRIPTION OF THE DRAWINGS

FIG. 1 is a schematic of an embodiment of a complete visible wideband laser for flat panel display illumination.

FIG. 2A depicts a typical emission bandwidth for a near-Infrared laser diode or other conventional near-Infrared light laser.

FIG. 2B depicts a typical emission bandwidth for a visible laser diode or other conventional visible light laser.

FIG. 2C depicts the emission passband spectra for a wavelength broadened multimode laser, showing center wavelength and mode spacing.

FIG. 3A illustrates a near-infrared laser cavity embodiment formed by a gain medium source and cavity reflectors.

FIG. 3B illustrates the output bandwidth spectra of the near-infrared laser cavity in FIG. 3A.

FIG. 4A shows the laser cavity embodiment shown in FIG. 3A seeded by a noise source LED or SLD.

FIG. 4B shows the emission passband spectra at two points in the laser cavity shown in FIG. 4A.

FIG. 5 shows the emission passband spectra for the laser shown in FIG. 1.

### DETAILED DESCRIPTION

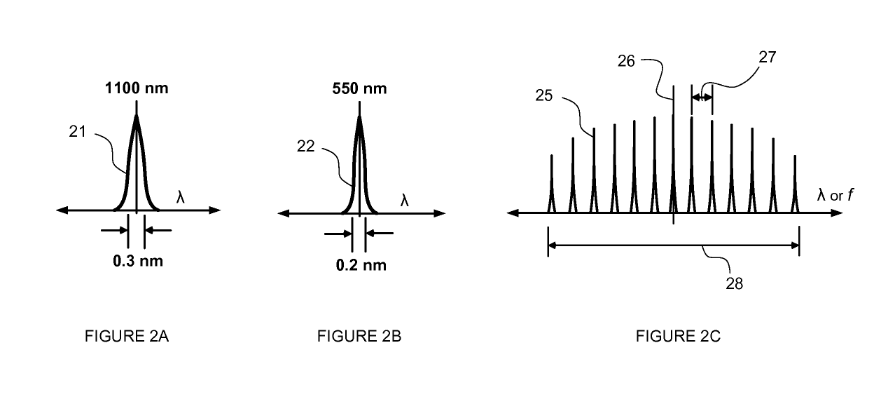

FIG. 2A depicts typical emission bandwidth mode spectra 21 for a near-Infrared laser diode (LD) or other conventional near-Infrared light laser with arbitrary center wavelength 1100 nm and 0.3 nm passband. FIG. 2B depicts a typical emission bandwidth mode spectra 22 for a visible LD or other conventional visible light laser with center wavelength 550 nm and 0.2 nm passband. As with most semiconductor lasers, these conventional devices lase in typically non-homogeneous gain media, thereby supporting only one dominant emission mode, with perhaps a few peripheral modes of lesser strength surrounding the dominant mode. Single mode versions of these types of lasers are formed by suppressing the surrounding modes such that only a single mode is emitted. These narrow emission mode spectra are often referred to as laser “lines” because their spectral modes are so narrow that they appear in most graphical scales to appear as a line.

A broadened multi-mode laser emission passband spectra relevant to the disclosures herein is shown in FIG. 2C, illustrating center wavelength (or frequency) 26, typical mode 25, mode spacing 27, and overall passband 28. Note that modes can be expressed in either wavelength space or frequency space, each related to the other by

cₘ=f*λ

where cₘ is the speed of light in the laser cavity media, f is the frequency and λ is the wavelength.

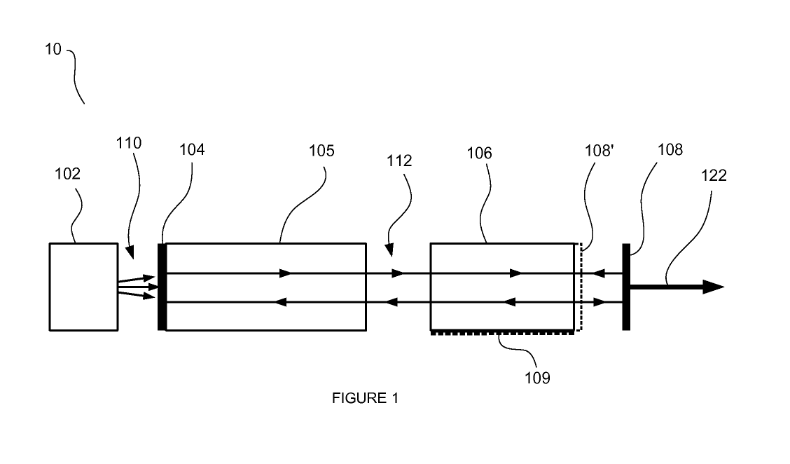

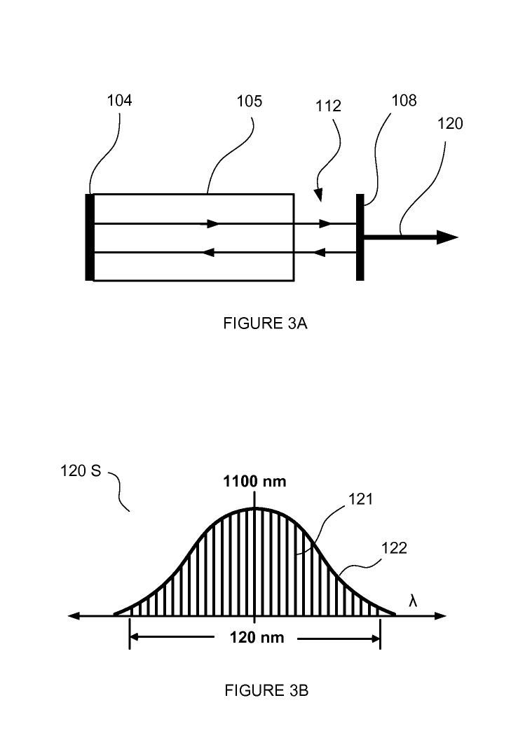

To establish a laser embodiment with wideband semiconductor laser emission suitable for flat panel display illumination, as shown in FIG. 1, visible wideband laser 10 is disclosed. The arrangement of components in FIG. 3A and output spectra 120S shown in FIG. 3B show only the fundamental gain medium and resonance properties for purposes of illustration. The complete embodiment would include additional components that are not necessary to the illustration. FIG. 3A depicts a schematic of a fundamental laser cavity relevant to the description and disclosure of the wideband laser utilized by embodiments of the invention. It is formed in part by homogeneous gain medium 105, back reflector 104 and output coupler 108. A homogeneous gain medium is one wherein multiple laser lines can simultaneously lase, i.e. producing a very wide gain profile, and is purposely fabricated to this end. These media are characterized as establishing high degrees of photon confinement attained by small dimensional apertures, as well as further molecular confinement comprised of quantum dots or other sub-wavelength structures fabricated periodically within the gain media depositions. These elements are often constructed to perform most effectively about a desired center near-IR wavelength, arbitrarily depicted in FIG. 3B as 1100 nm. Although there is no direct photon source embodied in this arrangement, population inversion occurs by zero-point photon energy when gain media 105 is energized electrically. Feedback caused by the bidirectional circulating lasing cavity beam 112 passing through gain media 105 occurs by cavity resonance induced by back reflector 104 and output coupler 108, causing stimulated emission to occur, resulting in ultra-wideband IR laser output 120.

To effectively eliminate cavity interference, high quality antireflection coatings may be applied to the front and back aperture faces of gain medium 105. The ideal reflectance values comprising both back reflector 104 and output coupler 108, usually established by thin film coatings, are design values optimized for the best performance of complete laser assembly 10, yet to be described. Optimal reflectance values of back reflector 104 and output coupler 108 are calculated using methods well known in the trade.

FIG. 3B illustrates an example of laser output spectra 120S comprised of ultra-wideband lasing power profile 122 distributed across all possible modes 121, shown with center IR wavelength 1100 nm and 120 nm full bandwidth. While the center IR wavelength, for illustrative purposes, is shown to be 1100 nm in all figure examples, any IR center wavelength is relevant providing that its frequency conversion to a visible wavelength is suitable for a particular display color primary. An 1100 nm center IR wavelength upon SHG conversion to visible light corresponds to a 550 nm ideal green primary at the center of the photopic curve and compatible with green LCD color filters, a critical wavelength conventional LDs cannot deliver.

The construction in FIG. 3A produces an undesirably wide lasing passband comprised of an undesirably high number of modes. To narrow the IR output spectrum and distribute the laser power over a suitable distribution of IR modes, photon noise source 102 is disclosed.

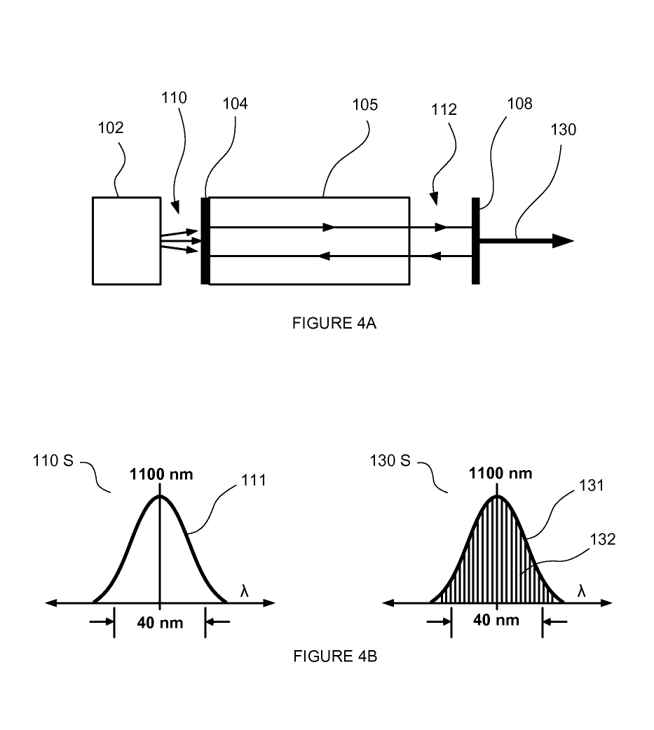

To reduce the wide IR passband about the center wavelength to a narrower one more suitable for frequency conversion to visible light, as depicted in FIG. 4A, a near-infrared monochrome light emitting diode (LED) source 102, or superluminescent diode (SLD) source 102 with center wavelength approximately equal to that of the gain medium is introduced in close proximity behind back reflector 104, acting as an extra-cavity component, i.e. located outside the cavity defined by back reflector 104 and output coupler 108. Either of these types of emitting diode is suitable and the choice depends essentially on their angular and wavelength distribution properties. If the reflectance properties of back reflector 104 are properly defined, a portion of SLD 102 emission 110 enters the resonating cavity, providing a photon “noise” source capable of seeding gain medium 105 with IR photons of the desired passband, causing these wavelengths to preferentially resonate within gain medium 105 in stimulated emission.

Spectra 110S in FIG. 4B illustrates the continuous narrower emission band 111 from LED or SLD 102 (arbitrarily shown as 40 nm wide), while spectra 130S illustrates the modal emission band 131 in laser output 130. The result is a means to leverage the broad gain profile of gain medium 105 and its potential for wide passband operations while only lasing IR modes that are useful to display illumination upon frequency conversion to visible light. While the reflectance values of back reflector 104 and output coupler 108, in percent reflection, are fundamental to the feedback performance of the laser cavity, adjusting their IR passbands is useful to further restrict or trim the resonating wavelength modes allowed to lase in gain medium 105. Back reflector 104 and output coupler 108 are generally set at nearly identical wavelength passbands but not necessarily so.

The optical element assemblage comprising the IR stage described thus far in FIG. 3A and FIG. 4A establishes suitable IR cavity circulation spectra as depicted in FIG. 3B and FIG. 4B. The final stage necessary to convert the near-IR lasing mode passband into visible light and thus establishing the complete visible wideband laser 10, intra-cavity converter element 106 is disclosed.

As illustrated in FIG. 1, nonlinear optic wavelength converter element 106 is axially positioned within the resonant optical cavity defined by back reflector 104 and output coupler 108. As is well known in the photonics trade, the optical axis of converter element 106 should be centered along the intra-cavity lasing axis such that it is collinear, and that its front and back apertures are properly specified to transmit the complete pupillary extent of bidirectional circulating IR cavity beam 112. Also, output reflector 108, defining the length of the resonating cavity, can be positioned at any valid position along the lasing axis from position 108′, e.g. in abutment to converter element 106, or elsewhere along the lasing axis of the cavity formed by back reflector 104 and output reflector 108. In the case of abutments of back reflector 104 to gain medium 105, and output reflector 108′ to converter 106, these abutments can bound either air gaps or immersion coupled gaps. As is common in the optics trade, either contact method can be implemented providing the wavelength reflection coatings on each of the four optical faces involved are properly designed for each case.

Converter element 106 is generally comprised of, but not limited to, nonlinear optic crystal materials such as Lithium Tantalate (LiTaO3), Lithium Niobate (LiNbO3), or other similarly suitable nonlinear optic materials. Nonlinear optic materials are often comprised of certain ordered molecular crystal structures found in nature, though not exclusively, as organic and synthetic molecular substances are also applicable.

Nonlinearity in an optical material describes a response to transmitted incident light that differs from common optical materials. The principle of superposition applies in common materials when a light beam passes through them because in this interaction there is a proportional, i.e. linear mathematical relationship between the light's electric field and the material's dielectric polarization. When a light beam passes through a nonlinear optic material, the principle of superposition does not apply in the interaction because there is a strongly nonlinear mathematical relationship between the light's electric field and the material's dielectric polarization. This interaction of nonlinear parameters can cause large, disproportional effects such as the summing of two incident light frequencies or the doubling of a single incident frequency. The salient properties of these nonlinear materials relevant for use as intra-cavity converter element 106 establish that the materials are strongly birefringent, i.e. their molecular lattices are axially symmetric with substantially differing refractive indexes in the two orthogonal directions, that they are transparent to the incident laser light wavelength as well as the frequency doubled output wavelength, and they have high damage thresholds at the significant power densities required to yield strong nonlinear interactions with the incident light.

Importantly, these crystals can be fabricated as planar photonic circuits comprised of accurate minute waveguides that very tightly confine laser light, which in turn, produces more efficient IR to visible conversion, as well as high volume manufacture in glass wafer dielectric processes analogous to silicon wafer manufacture.

Using nonlinear materials to achieve SHG (second order harmonic generation) and other conversions in the frequency of light is derived from the basic physical process known as three-wave-mixing, wherein two photons of lower energy light are converted into one photon of higher energy light. Collinearity of all optical frequencies, as well as them all having the same polarization, improves energy conversion. Key to the efficiency of this interaction is to enable a positive flow of energy from IR drive input to visible laser output. This will generally occur if the phase between the two light frequencies are within 180°, otherwise energy will flow uselessly backward from output to drive. For optimized conversion between the frequencies with minimal loss, a method known in the prior art as quasi-phase-matching (QPM) is often implemented in SHG lasers. This establishes a permanently positive net flow of energy from the IR drive light to the visible SHG output light within the nonlinear element, despite that the optical frequencies are not phase locked to one another. Periodic poling is generally the most common method for establishing quasi-phase-matching in a nonlinear material, whereupon a spatially alternating polarization domain structure is established on the material's surface. The polarized beams of both drive and output light interact with the periodic poling structure such that the net phase between them is perpetually reversed, resulting in the net phase remaining less than 180°. Design of periodically poled QPM structures for given materials are well known in the optics trade.

In FIG. 1, periodically poled structure 109 is depicted on one surface of intra-cavity conversion element 106, which completes the component assemblage for the visible wideband laser 10. FIG. 1 also depicts SHG visible laser output beam 122, which emits at 550 nm wavelength with the near-IR drive wavelength example shown in FIG. 3B and FIG. 4B centered at 1100 nm.

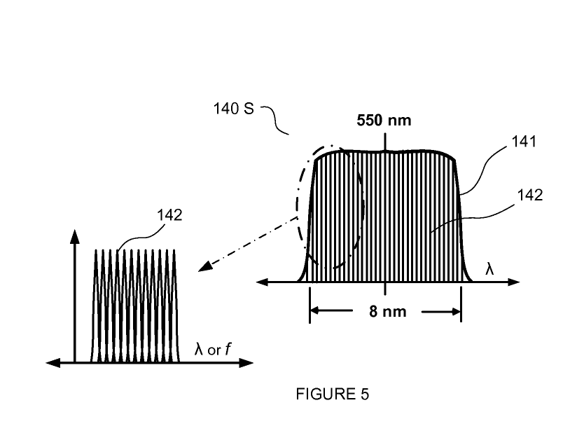

Output laser beam 122 as illustrated in FIG. 1 is comprised of emission spectrum 140S as depicted in FIG. 5. Numerous visible light laser output modes 142 with 8 nm passband 141 are also depicted in FIG. 5. The aggregate effect of the numerous converted independently lasing output modes 142, the significantly widened passband 141, and their inherently close spectral proximity to one another without overlapping, significantly reduces speckle in the visible output laser beam output.

A manner in which the visible wideband laser 10 component arrangement is adapted for the wideband visible laser output 140S depicted in FIG. 5, and depends on the chosen IR mode configuration as depicted in FIG. 2C. An advantageous mode distribution is established about center wavelength 26 across passband 28 such that after the SHG doubling an advantageously small mode spacing 27 is produced without the separation of modes being too small or overlapping. The frequency of each mode 25 in FIG. 2C is generated in the IR stage by a round trip through the complete resonator cavity and is defined by

f=cₘ/2L

where f is the frequency of the mode, cₘ is the speed of light in the laser cavity media et al, and L is the total optical length of the cavity. Thus it is the optical length of the cavity that essentially determines the final frequency/wavelength of each mode. The wavelength passbands that actually lase in the IR stage and become available for SHG conversion are determined by the IR stage coatings. Beam power output vs. wavelength is essentially determined by how many modes within the passband are contributing to the total laser output power.

What is claimed is:

1. A wideband visible light laser, comprising:
a laser cavity resonator comprising a first partial reflector defining the first terminating end of the cavity, and a second end reflector defining the second terminating end of the cavity and wherefrom visible light laser emission exits the cavity;
the first and second end reflectors configured for the partial reflection of incident light, and the second reflector configured for the partial reflection of incident light in order to establish optical feedback;
a first intra-cavity element comprising a homogeneous gain medium material;
a second intra-cavity material element comprising a nonlinear optic material aligned in the cavity with the first intra-cavity element so as to establish optical frequency conversion of the circulating light in the resonator, the second intra-cavity element configured to cause nonlinear feedback of light circulating in the cavity resonator;
a first extra-cavity photon noise source element comprising an emission source suitable to enter the first laser resonator cavity through the first partial reflector;
the first extra-cavity photon noise source element configured with a specific emission passband profile to cause stimulated emission in the first intra-cavity material within a particular passband; and
a first phase-matching structure attendant to the second intra-cavity material element configured to maintain proper phase of the circulating light within the second intra-cavity nonlinear material.

2. The visible light laser of claim 1, wherein the extra-cavity photon noise source element is a light emitting diode (LED) formed and arranged to cause incident light to enter the cavity through the first partial reflector.

3. The visible light laser of claim 1, wherein the extra-cavity photon noise source element is a superluminescent light emitting diode (SLD) formed and arranged to cause incident light to enter the cavity through the first partial reflector.

4. The visible light laser of claim 1, wherein the first intra-cavity homogeneous gain medium material comprises a structure of subwavelength particle elements arranged to spatially confine and constrain the cavity photons in one, two or three dimensions.

5. The visible light laser of claim 1, further comprising:
a second optical coating on the first end reflector arranged to adjust the transmission amplitude of the extra-cavity photon noise source element emission into the cavity.

6. The visible light laser of claim 1, further comprising:
a second optical coating on the second end reflector arranged to cause adjust the amplitude of nonlinear feedback relative to the laser beam output transmission out of the cavity.

7. The visible light laser of claim 1, further comprising:
the first phase matching structure attendant to the second intra-cavity material element is achieved by periodic polling of polarization of the second intra-cavity material structure.

8. The visible light laser of claim 1, wherein the second intra-cavity material element comprising a nonlinear optic frequency converter is arranged to cause second harmonic generation of the source frequency.

9. The visible light laser of claim 8, wherein the second intra-cavity material element comprising a nonlinear optic frequency converter is arranged to establish any allowed frequency conversion type.
